(19) United States
(12) Patent Application Publication
(10) Pub. No.: US 2004/0203928 A1
(43) Pub. Date: Oct. 14, 2004

(54) System and method for binning and indexing spatially relevant data

(76) Inventors: Scott C. Nevin, Windsor, CA (US); Stephen R. Peterson, Santa Rosa, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/106,166

(22) Filed: Mar. 26, 2002

(51) Int. Cl. H04Q 7/20

(52) U.S. Cl. 455/457; 455/566; 455/414.1

(57) ABSTRACT

Systems and methods for binning spatially relevant data and corresponding geographical location information are disclosed. In a preferred embodiment, the system comprises at least one transmission device operable to transmit spatially relevant data and corresponding location information for the data to a server. Preferably, an instruction set is executable by a processor-based device (e.g., the transmission device or the server) for generating a single spatial index value for the location information. Accordingly, the spatially relevant data may be indexed using its corresponding spatial index value.

### TECHNICAL FIELD

The present invention relates in general to cartography, and more specifically to a system and method for binning and indexing spatially relevant data.

### BACKGROUND OF THE INVENTION

Deployment of data transmission devices for conveying statistical and performance data is well known in the art. Data transmission devices (e.g., probes) are often deployed in a geographically distributed manner such that the deployed devices convey data from different geographic locations to, for example, a central server. For example, a plurality of probes may be geographically distributed throughout a region and may each convey data from and/or regarding their respective location. Further, a single probe may be transported to various different geographic locations and may convey information from and/or regarding the different locations at different times. This probe may queue data before transmitting it to a central server. Such devices also often convey spatial and temporal information, which may be used to manage and categorize the received data based on location and time.

Deployed devices may exist, for example, as wireless network probes that, among other things, test signal strength and intensity within wireless networks. Data collected and transmitted by the probes may ultimately indicate sources of network problems and assist in network troubleshooting. In addition to wireless networks, numerous other systems collect spatially relevant data that may be indexed by location. For example, systems may be used to track animal populations in geographic regions. It is often desirable to categorize the data based on the location relevant to the data.

Management of received data becomes increasingly complex as the number of deployed data transmission devices increases (and/or as the number of different locations from which data is conveyed from a transportable transmission device increases). For instance, as a relatively large number of wireless network measurement probes are deployed (or as the number of locations from which data is conveyed from a transportable measurement probe increases), relatively large volumes of call statistics and performance data for this wireless network may be generated. In order to extract meaningful performance information at the network system level, it often becomes desirable to index the data spatially for statistical correlation. It may also be desirable to correlate the data at varying spatial resolutions.

### BRIEF SUMMARY OF THE INVENTION

The present invention is directed to systems and methods for binning spatially relevant data and corresponding geographical location information. In a preferred embodiment, the system comprises at least one transmission device operable to transmit spatially relevant data and corresponding location information for the data to a server. Preferably, an instruction set is executable by a processor-based device (e.g., the transmission device or the server) for generating a single spatial index value (SID) for the location information. Accordingly, the spatially relevant data may be indexed using its corresponding spatial index value.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1A is an example diagram depicting the concentration of data transmission devices or multiple data points from a small number of devices distributed within a geographic region;

FIG. 1B is an example of a prior art system to which geographically distributed data transmission devices report data;

FIG. 2 shows an example system in which embodiments of the present invention may be implemented;

FIG. 3 is a block diagram of one method of generating a single spatial index from location information; and

FIG. 4 is a block diagram of one method of converting a single spatial index into location information.

### DETAILED DESCRIPTION OF THE INVENTION

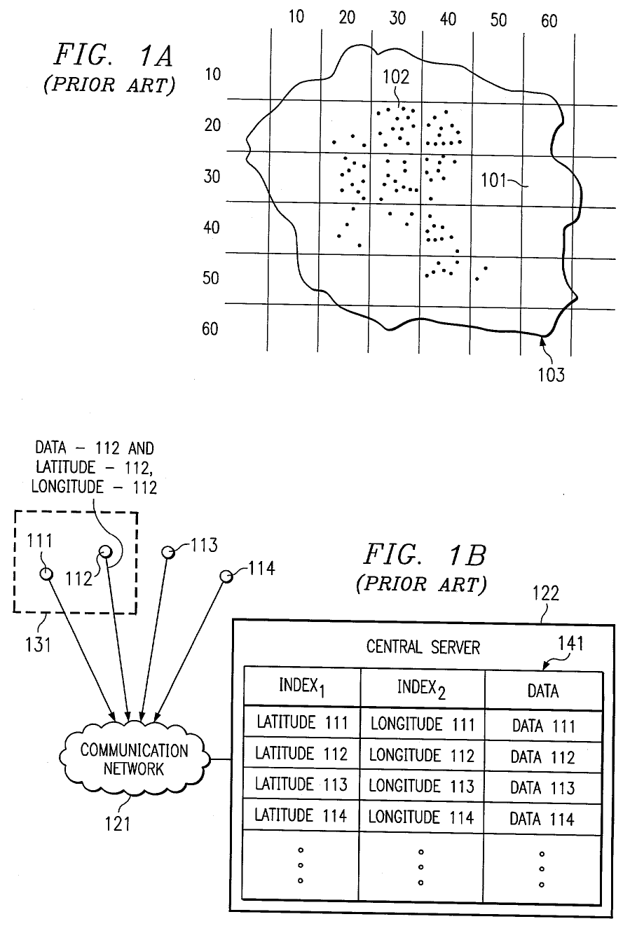

In many systems, such as in wireless network monitoring systems, geographically distributed spatially relevant data may be obtained by a plurality of distributed probes and/or by one or more probes that is/are transported to different areas. FIG. 1A example diagram depicting the concentration of data transmission devices or multiple data points from a small number of devices distributed within a geographic region. The diagram may be used to illustrates an example of a method used in the prior art for acquiring distributed spatially relevant data from data transmission devices (e.g., probes). In this diagram, a multitude of locations from which spatially relevant data is acquired by one or more transmission devices are represented by individual points across region 103. For example, data regarding the strength of a wireless signal of a wireless communication network may be acquired for each location represented by an individual point (or dot), and such data may be communicated to a network monitoring system (e.g., a central server) to enable a network administrator to evaluate the performance of the wireless network and/or identify problem areas within the wireless network. In various alternative implementations, the data transmission devices may be dedicated devices for acquiring spatially relevant data (e.g., network performance data) or the data transmission devices may be included within a device having added functionality (e.g., included within a mobile telephone for acquiring performance data for the wireless network at various different locations to which the mobile telephone is transported).

Spatial and/or temporal information may be included with the acquired data, which the monitoring system may utilize to categorize and/or analyze the data based on the location and/or time at which it was acquired. For instance, the monitoring system (e.g., central server) to which the spatially relevant data is communicated may index the data based on the location from which it was acquired (and/or the location to which it relates).

In typical methods of the prior art, latitude and longitudinal coordinates identifying the location at which the spatially relevant data was acquired is communicated from the transmission devices to the monitoring system. The location information is then stored and categorized into a pre-existing matrix. In prior art systems, the matrix used is first created for a specific spatial resolution. For example, a system which intends to categorize a region into 10 meter by 10 meter locations does so by calculating latitude and longitude boundary values that correlate to each individual 10 meter increment. In the prior art, a set of reference origins are often used to calculate the index used to access the matrix. For example, calculating the difference between a given location's latitude and a chosen latitude origin and then dividing the difference by a desired provides the first offset used to index the matrix. A major drawback of note in this method is the floating point values which are generated. The system proceeds to calculate a longitude offset in the same manner using a chosen longitude origin. Calculation of both points allows the system to place data sent by each transmission device into the corresponding location (or “bin”) in the matrix.

Unfortunately, numerous problems exist with this prior art approach for managing spatially relevant data. First, the computational cost of categorizing the spatially relevant data into the correct cell of a matrix based on two separate spatial indices (e.g., latitude and longitude) is undesirably high. For instance, when presented with fifty data samples and their location in latitude and longitude, the prior art requires a system perform a multi-variable lookup in order to view information by location. In the prior art, one set of operations is required to sort by location information and a separate set of operations are required to bin by location information. Thus, after sorting based on a single variable (e.g., longitude or latitude values associated with each datum), in order to bin the prior art system must still perform additional operations such as, calculating the latitude and longitude boundaries of each region based on the region size and performing comparisons on the latitude and the longitude values of each individual data point against the calculated region boundaries. Usage of two indices (i.e., latitude and longitude) requires at least two value comparisons between each index and a boundary value for each set of locations. This results in a series of comparisons that are computationally expensive.

As is evident, this process as a whole is time consuming. Also, storing spatially relevant data to a pre-existing matrix having a predetermined resolution often results in inefficient use of storage capacity. For instance, as each cell in the matrix may or may not be used at all, much of the dedicated memory space may be wasted. An example of this is depicted at location cell 101 of FIG. 1A. Location cell 101, among other location cells, lacks any data transmission devices, yet it exists as part of the defined matrix on the computational server. Further, location cell 101 may be a location at which data may likely never be acquired by a data transmission device, for example in the middle of an ocean. In prior art methods, although a location is known as one that will likely not ever be populated, the system is required to allocate space for such location in the pre-defined matrix.

Another problem with the prior art method is the lack of a simple process to conceptualize the received data in different resolutions after the initial categorization process. For instance, moving from a resolution of 10 meters by 10 meters to that of 100 meters by 100 meters requires recalculation of location boundaries and another comparison of the latitude and longitude associated with the received data from each transmission device.

The prior art lacks an effective means of a combined sorting and binning data by location. Instead, any attempt to sort, requires sorting by one of the multiple variables used to identify a location (e.g., latitude and longitude), which results in data-striping. In this sense, data-striping occurs when a sort by one of a set of variables results in shuffling of a previous sort by another set of variables. In order to categorize data based on multiple sorts based on each individual variable are required. Furthermore, use of floating point numbers in the prior art to represent location information (for instance exact latitude and longitude coordinates) is computationally expensive when compared to handling other forms of numerical data, such as fixed point data.

FIG. 1B depicts an example of a prior art system in which data is stored on an individual basis before being binned. Thus, transmission devices 111-114 are deployed to acquire spatially relevant data for their respective locations. Each of transmission devices 111-114 relay information via communication network 121 to Central Server 122. As data is received by Central Server 122, the spatial indices, latitude and longitude in this case, are stored with the corresponding received data. For example, data relayed by transmission device 112 to Central server 122 is stored into Data Array (or matrix) 141. Latitude-112 and Longitude-112 represent the numerical values of the transmitted latitude and longitude information associated with the data from probe 112. Both values serve as spatial indices to the transmitted data, Data-112. When an attempt is made to access the data stored in matrix 141 based on location cells (e.g., a 10 meter by 10 meter region), latitude and longitude boundaries are calculated and used to categorize each location as described above. In this example, allocating memory for a pre-defined matrix as in FIG. 1A is not performed, but instead, memory is only allocated when it is needed to store data and/or location information. This results in memory being used when it is required and reduces the large segments of unused allocated memory. While alleviating the memory issue, much of the negative side affects existent in the previous method are still present. For example, because the spatial data is indexed with two separate spatial indices (latitude and longitude), computational cost for searching through and analyzing the data is great.

In general, embodiments of the present invention provide a system and method to bin and index spatially relevant data in an efficient manner. According to at least one embodiment of the present invention, a single numerical value is utilized for indexing spatially relevant data. Such single numerical value may represent a region having a plurality of discrete locations, such as a 10 meter by 10 meter region. In some embodiments, the single numerical value may be a fixed point numerical value in order to take advantage of common processors optimized for fixed point calculations. Further, in embodiments of the present invention, a SID is generated that allows for sorting and binning of data in a single operation.

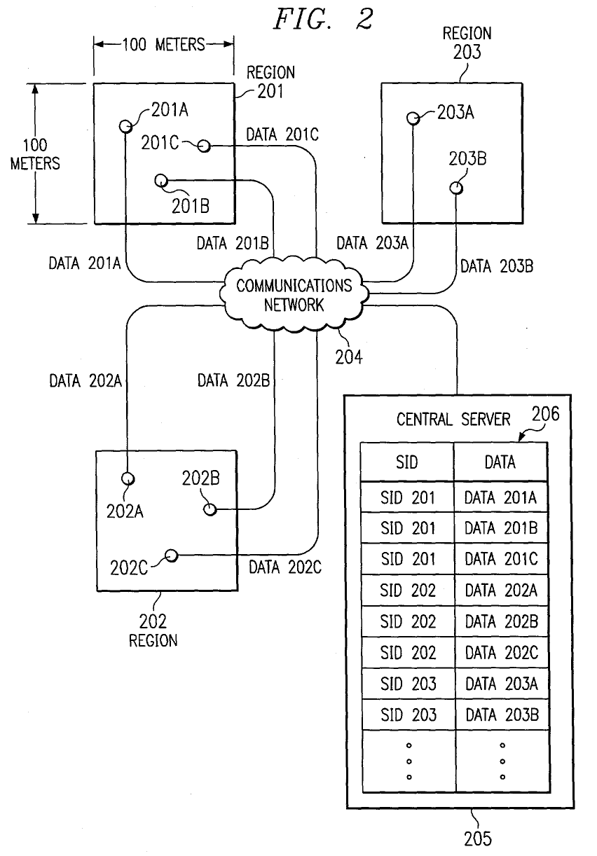

FIG. 2 depicts an example system in which embodiments of the present invention may be implemented, wherein data received from deployed transmission devices is indexed using a single location value. Data points 201A-201C, 202A-202C, and 203A-203B exist in regions 201, 202, and 203, respectively, at a given location identified by the corresponding location information. More specifically, data points 201A-203B each comprise data related to a discrete geographical location that is communicated via communications network 204 to central server 205. Data points 201A-203B may, among other methods, be locations for which data is transmitted by one or more transmission devices travelling throughout the region(s) or may each represent individual transmission devices. Data points 201A-203B may depict a wide variety of spatial data, such as power measurements within a wireless network, as well as corresponding location information that identifies the data point location to which the spatially relevant data relates.

As data for each individual data point 201A-203B is received through communications network 204, central server 205 computes a spatial identifier (SID) based on the provided location information. The location information provided by the system may be represented in various manners, such as a latitude and longitude pair, Universal Transverse Mercator (UTM) format, or any other suitable method of referencing a location. In a preferred embodiment, the location format used is UTM. The UTM standard expresses location information using three components, a zone designation, an easting component, and a northing component. The zone designation represents one of sixty longitudinal zones defined by the UTM standard. The UTM format is well known, and is therefore not described in further detail herein. For further information regarding the UTM format, refer to the description of the UTM grid written by N. G. Terry, Jr of Advanstar Communications as published in GPS World, the disclosure of which is incorporate herein by reference.

Spatially relevant data of data point 201A and its corresponding location information are received by Central Server 205. Central Server 205 resolves the location into an SID (shown as SID 201 in FIG. 2) using the algorithm described below. In this example, data point 201A is within region 201, which is a 100×100 meter area in the example of FIG. 2. Of course, in other implementations Region 201 may be of any dimension such as 1250×750 meters, 16×16 meters, or 1×1 meters. Preferably regions may be either rectangular or square, but it should be appreciated that choosing to implement a square region may result in more efficient computations.

At a later point in time, data for data point 201B may be received by Central Server 205. Using the algorithm described later, an SID is computed for data point 201B. As is the intention of a preferred embodiment of the present invention, the SID computed for data point 201B in this example will be identical to the SID computed for data point 201A (i.e., SID 201 of FIG. 2). Computation of data point 201C's SID follows suit and is thus identical. Data corresponding to data points 202A-C may also be received by central server 205. In this case, the same procedure used to generate SIDs for data points 201A-C is used to generate SIDs for data points 202A-C's location information. The same procedure is preformed using location information of data points 203A-B, resulting in SID 203 being generated for both. The procedure produces a common SID for all locations within a particular region, which as described above may be of any desired dimension. This is visible in data table 206 wherein data points 201A-201C each have identical SID values represented by SID 201, data points 202A-C correspond to SID 202, and 203A-B correspond to SID 203. In this manner, the system bins the spatially relevant data received from various transmission devices with data of the same region of a desired spatial resolution.

Additionally, regions that do not contain any transmission devices or information preferably do not have memory allocated to them during analysis. In addition to saving memory, it should be recognized that sorting and manipulating the received data is much faster than with prior methods because of the data being indexed with a single spatial fixed point index (SID) rather than being indexed with two floating point indexes (e.g. latitude and longitude). It will be appreciated that when using this method, sorting by SID results in all values sorted adjacent to data geographically similar, as opposed the striping that is common in the prior art.

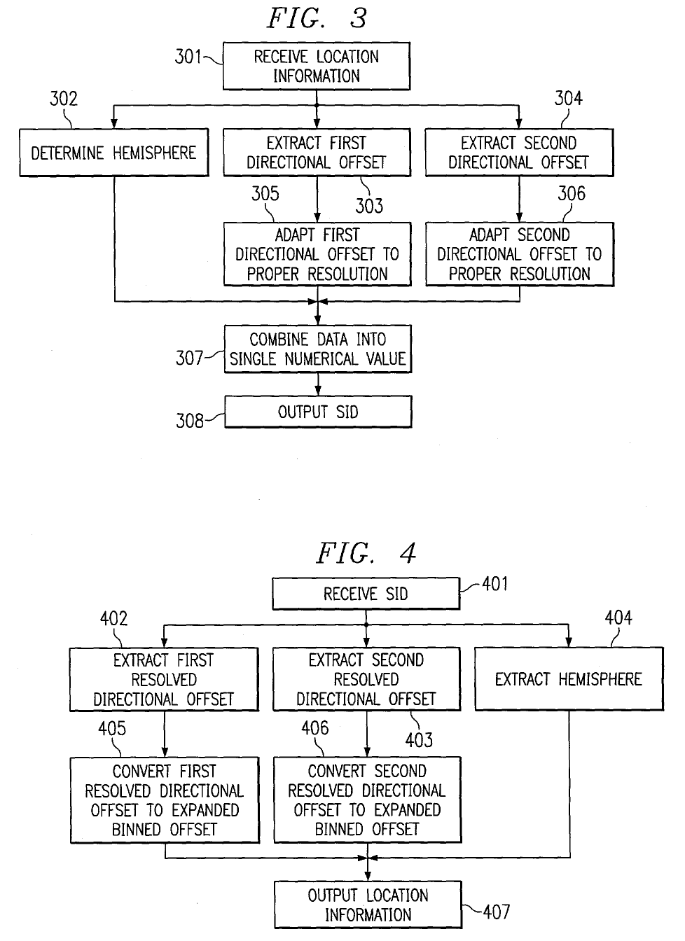

An example implementation of an algorithm used to generate the unique spatial index in accordance with a preferred embodiment is detailed in FIG. 3. The process begins by receiving location information at operational block 301. From the location information, the system extracts hemisphere information at operational block 302, extracts a first directional offset at block 303, and extracts the second directional offset at block 304. Each of tasks 302-304 may be done concurrently, if it is so desired. In some cases, location information may be received as a structure with the various components of the desired location format. Preferably, the location information received at block 301 is in UTM format. In the case of the UTM format, the three components, zoning, easting, and northing, are used in generating a unique spatial index. The zoning coordinate contains information regarding hemisphere, thereby allowing us to determine a location's hemisphere. The easting and northing components serve as directional offsets one and two respectively. As such, the algorithm would obtain the two offsets from the location information received in block 301.

Next, the desired spatial resolution at which data is to be indexed is determined at block 305, the first extracted directional offset is adapted to the proper resolution, depending on the determined resolution for indexing. Identical action is taken at block 306, using the value of the second extracted directional offset. Determining the proper spatial resolution at which data is to be indexed may include division or truncation of directional offsets. Operation block 307 combines the first and second resolved directional offsets and hemisphere information into a single value, most often a numerical value. This value is the desired SID, which is then returned to the calling system at operational block 308. Variables dependent on location information format, such as hemisphere information, are used only as illustration, and SID generating algorithms that may be implemented in alternative embodiments are not intended to be limited to this example.

An example of Java code implementing the above process using the location format of Universal Transverse Mercator (UTM) is provided below.

```
public long toSID( ) {
    long northernhemisphere = (zone_letter > ‘M’ ? 1 : 0);
    long lowword = (long)( northenhemisphere << 31) +
            (long)(northing / (long) resolution);
    long highword = (long)( zone_number << 24) +
            (long)( easting / (long) resolution);
    long sid = (highword << 32) | lowword;
    return sid;
}
```

As shown in the above example code, variable “northernhemisphere” is a value representing whether or not the acquired location is in the northern hemisphere. A comparison is made to see if the zone of the location information is greater than the equator zone M. A lowword value is created by concatenating the calculated northernhemisphere value with a resolution of the UTM northing value. The resolved UTM northing value is one that has, in this case, been truncated by a specified amount defined by the resolution value. This serves to create a value that is representative of a range of different specific UTM northing values. For instance, assuming a northing value of 987654321, by truncating and in essence disregarding the three least significant digits, the resolved value of 987654 is representative of all values 987654000-987654999. By also disregarding the least significant digits of the given easting value, a two dimensional region may be represented. The two resolved values along with the hemisphere location are combined, through the use of bit shifting and a bitwise OR operation, into the SID. This value is then provided to the calling code. The above code is intended solely as an example, and those of ordinary skill in the art will recognize various other coding techniques for generating an SID in accordance with embodiments of the present invention.

Often times it is desired to convert a given SID back into the original location information format. This allows for quick recategorization of location information to different resolution sizes. FIG. 4 presents an operational flow diagram of an example algorithm performing this conversion. At operational block 401, the function receives an SID. Blocks 402-404 extract the first and second resolved directional offset and the hemisphere from the SID, respectively. Conversion of the first resolved directional offset into an expanded offset is performed at block 405. Expansion can be done in a number of ways, such as adding arbitrary information to the resolved offest to create a UTM northing/easting value or accessing information about UTM northing/easting that the system was previously instructed to disregard. This offset may or may not be binned, depending on the previously selected resolution and the method of adaptation. Block 406 converts the second resolved directional offset into an expanded offset. Each of the three pieces of information constituting the location information is then return to the calling system at block 407. Once received by the calling system, the location information may be used to generate a SID of a different spatial resolution, for example. It may also be possible to combine the actions taken in both the location information to SID conversion and SID to Location information into a single function which accepts an SID, changes the resolution to a different resolution, and outputs a SID for such different spatial resolution.

An example implementation of the SID to Location information process is provided below, in which the location format used is UTM:

```
public UTM SIDtoUTM( long sid, UTM utm) {
    int lowword = (int) sid;
    int northernhemisphere = lowword & (1 << 31);
    int north = (˜northernhemisphere & lowword) * resolution;
    int highword = (int) (sid >> 32);
    int zone = (highword >> 24);
    int east = (highword & 0x00ffffff) * resolution;
    if( utm != null) {
        utm.northing = north;
        utm.easting = east;
        utm.zone_number = zone;
        utm.zone_letter = (northernhemisphere != 0 ?
                ‘N’ : ‘M’));
        return utm;
    }
    else {
        return new UTM( north, east, zone,
            ( northernhemisphere != 0 ? ‘N’ : ‘M’));
    }
}
```

In the preceding code example, the northern hemisphere is extracted from the most significant bit of the given SID and set to the variable northernhemisphere. The northing and easting values are also extracted through bit manipulation. Both extracted values are multiplied by the resolution value used in the conversion to a SID. Alternately, a different embodiment may instead designate that a UTM structure recognize a previously disregarded, abstracted or hidden data, thereby allowing full recovery of location information. A UTM structure is then filled with the calculated hemisphere, northing, and easting values and returned to the calling function. The above code is intended solely as an example, and those of ordinary skill in the art will recognize various other coding techniques for generating an SID in accordance with embodiments of the present invention.

A single spatial index (SID) can be generated for spatially relevant data to enable computational efficiency in handling such data (e.g. searching it, performing statistical analysis, etc). A SID is used to index and sort spatially relevant data without requiring the comparison of a set of two location values. The generation of the index may not require a reference point when moving between different service areas. Furthermore, the ability to readily change the spatial resolution at which the data is indexed is another advantage of the present invention. In some embodiments, executable code that converts to and from location information and SIDs may also receive user input specifying the desired spatial resolution in which to use during SID calculation. Such user input may be in a number of various forms including, input through a graphical user interface, provided as a parameter to a function, or as a command line option defining the value.

Embodiments of the present invention may be implemented as computer-executable software code, which may for example be stored to a computer-readable medium, such as RAM, hard drive, CD, floppy disk, etc. Furthermore, such executable software code may be executed on any suitable processor, such as an Intel™ Pentium™ processor. The coupling of data probes to a central server could be wired or wireless, and may implement a number of various communication protocols.

While a preferred embodiment has been described utilizing UTM location format, other embodiments may use other location formatting, such as latitude and longitude and map coordinate systems. That is, while a preferred embodiment utilizes location information formatted as UTM to generate a SID for indexing spatially relevant data, other embodiments may generate such a SID using location information formatted in some other way (e.g., latitude and longitude values).

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A system for binning spatially relevant data, the system comprising:
at least one transmission device operable to transmit spatially relevant data;
at least one server communicatively coupled to said at least one transmission device, said at least one server operable to receive said spatially relevant data; and
an instruction set executable by a processor-based device for generating a single spatial index value from location information correspond to said spatially relevant data.

2. The system of claim 1 wherein said single spatial index value is generated for said location information such that said spatial index value identifies locations within a common region defined by a resolution.

3. The system of claim 1 wherein said at least one transmission device queues said spatially relevant data transmitting said spatially relevant data and location information to said at least one server.

4. The system of claim 1 wherein said instruction set is executable on said at least one transmission device, thereby allowing said at least one transmission device to convert said location information to said single spatial index value.

5. The system of claim 1 wherein said instruction set is executable on said at least one server.

6. The system of claim 1 wherein said location information is formatted in Universal Transverse Mercator format.

7. The system of claim 1 wherein said at least one transmission device is a wireless probe, and wherein said spatially relevant data comprised quality data for a wireless network.

8. The system of claim 1 wherein the instruction set comprises:
code for extracting at least one individual location variable from location information;
code for resolving into a desired resolution said at least one individual location variable; and
code for merging said resolved at least one location variable into a singular value representative of the region containing the location information.

9. The system of claim 1 wherein said single spatial index value has a spatial resolution input by a user.

10. A method of generating a single spatial index corresponding to a geographical comprising the steps of:
receiving location information identifying a discrete location;
extracting at least one individual location variable from said location information;
resolving into a desired spatial resolution said at least one individual location variable; and
generating from said resolved at least one individual location variable a single value representative of a region determined by said spatial resolution and encompassing said discrete location.

11. The method of claim 10 wherein said location information is comprised of:
a directional offset indicating vertical position; and
a directional offset indicating horizontal positioning.

12. The method of claim 11 wherein said location information is further comprised of:
a value designating said location's hemisphere.

13. The method of claim 10 wherein said location information is stored in Universal Transverse Mercator format.

14. The method of claim 10 wherein said resolving step further comprises:
truncating said at least one individual location variable.

15. The method of claim 10 wherein said resolving step further comprises:
dividing said at least one individual location variable by a value.

16. The method of claim 10 wherein said step of generating comprises merging said at least one individual location variable into said single value.

17. The method of claim 10 wherein said region is determined by the desired spatial resolution

18. A method for indexing spatially relevant data comprising the steps of:
receiving spatially relevant data and corresponding geographical information that identifies a discrete geographical location to which said spatially relevant data relates; and
generating a single spatial index having a desired spatial resolution that identifies said discrete geographical location to which said spatially relevant data relates as being with a particular geographical region of said spatial resolution.

19. The method of claim 18 wherein the step of receiving further comprises receiving said spatially relevant data from at least one probe gathering operable to store said spatially relevant data.

20. The method of claim 18 wherein said generating step is performed by said at least one probe.

21. The method of claim 18 wherein said generating step is performed by a central server storing said spatially relevant data.

22. The method of claim 18 wherein:
said method is implemented within a wireless network; and
said spatially relevant data is quality data for said wireless network.

23. The method of claim 18 wherein said particular resolution comprises a resultion selected from the group consisting of:
1 meter by 1 meter, 100 meters by 100 meters, 1250 meters 750 meters, and 16 meters by 16 meters.

24. The method of claim 18 wherein said single spatial index is a fixed point value.
